(19) United States
(12) Patent Application Publication
(10) Pub. No.: US 2015/0260213 A1
(43) Pub. Date: Sep. 17, 2015

(54) EXPANSIBLE FIXING PLUG

(71) Applicant: FISCHERWERKE GMBH & CO. KG, Waldachtal (DE)

(72) Inventor: Aaron Daly, Pfalzgrafenweiler (DE)

(73) Assignee: fischerwerke GmbH & Co. KG, Waldachtal (DE)

(21) Appl. No.: 14/436,272

(22) PCT Filed: Nov. 13, 2013
(86) PCT No.: PCT/EP2013/003418

§ 371 Date: Apr. 16, 2015

(30) Foreign Application Priority Data
Nov. 21, 2012 (DE) 10 2012 111 227.4

(51) Int. Cl. F16B 19/00

(52) U.S. Cl. CPC F16B 19/002

(57) ABSTRACT

The invention relates to an expansible fixing plug having two limbs arranged opposite one another, from which there project in opposite circumferential directions, alternately, expansion elements which are hook-shaped in a side view. In order to improve guidance of an expander screw, the invention proposes that expansion elements in a front portion of an expansion region be connected in pairs by extensible and tearable connectors, which extend on a slant relative to the longitudinal direction of the fixing plug.

### TECHNICAL FIELD OF INVENTION

The invention relates to an expansible fixing plug.

### DISCUSSION OF RELATED ART

Fixing plugs, especially made of plastic material, are known. They are mainly sleeve-shaped so that they have a hollow space extending in a longitudinal direction of the fixing plug and forming an expansion channel into which a rod-like expander means for expanding the fixing plug can be introduced for the purpose of anchoring in a drilled hole. The rod-like expander means is, for example, a nail or a screw-nail which is driven into the expansible fixing plug and expands it, or a screw which is screwed into the expansible fixing plug and expands it. There are many different arrangements of such expansible fixing plugs, especially in respect of their expansion region. The expansion region is a longitudinal portion of the expansible fixing plug which is expanded as a result of introduction of the expander means.

European Patent Application EP 0 964 169 A2 discloses an expansible fixing plug having, arranged opposite one another and extending in a longitudinal direction of the fixing plug, two limbs from which, on both longitudinal sides, expansion elements project in a circumferential direction of the expansible fixing plug. In a side view of the expansible fixing plug, the expansion elements are triangular, with one side of the expansion elements extending in a radial plane of the expansible fixing plug and another side of the expansion elements extending on a slant relative to the expansible fixing plug. The expansion elements extend out from the two limbs in opposite circumferential directions; they fit into one another exactly without an intermediate space. When an expander screw is screwed into the expansible fixing plug, the expansion elements of the known expansible fixing plug are pivoted outwards about pivot axes that extend along the longitudinal sides of the limbs in the longitudinal direction of the plug, that is to say axially parallel to the expansible fixing plug. Pivoting of the expansion elements is possible as a result of the deformability of the expansible fixing plug, which is made of plastic material.

Patent specification DE 32 08 347 C1 discloses a sleeve-shaped expansible fixing plug also made of plastic material, having two limbs which are arranged opposite one another and which extend in a longitudinal direction of the fixing plug. The limbs have a Christmas-tree profile, which is to say that they have truncated cones which are arranged one after another axially and which at the larger-diameter, rear end are succeeded by a short cylindrical portion. In a side view of the expansible fixing plug the profile results in a sawtooth profile, the teeth of which are oriented opposite to the direction of pulling the expansible fixing plug out from a hole in an anchoring substrate. As a result of the Christmas-tree profile, teeth are formed on the limbs, which teeth extend over less than 180° in the circumferential direction so that gaps running in the longitudinal direction of the fixing plug exist between the teeth. In the circumferential direction, the teeth, in each case in one direction, overlap the limbs. Between the limbs there is a gap extending in the circumferential direction between the teeth of the known expansible fixing plug. At the locations overlapping the limbs in the circumferential direction, individual pairs of teeth are connected by longitudinal bridging parts which extend in the longitudinal direction of the expansible fixing plug and which have a small cross-section so that they are deformable and can tear. As stated, teeth are connected in pairs by the longitudinal bridging parts which in general terms can also be referred to as connectors; after every second tooth there is no connection, apart from the limbs, between the teeth projecting out in the circumferential direction from the limbs of the expansible fixing plug. The longitudinal connectors transfer tensile and compressive forces and as a result increase the flexural, buckling and torsional strength of the known expansible fixing plug.

In the case of expansible fixing plugs made of plastic material there is a problem that the expander rod, on being introduced into the expansible fixing plug, can exit laterally between two expansion elements as a result of stresses and deformation of the expansible fixing plug which occur in the course of expansion. Further to the front from the exit point the expansible fixing plug will no longer be expanded in the intended manner. “Front” and “rear” are used relative to the direction in which the expansible fixing plug is introduced; a front end of the expansible fixing plug faces the bottom of a hole in which the expansible fixing plug is being, or has been, anchored; a rear end of the expansible fixing plug is accessible when the expansible fixing plug has been introduced into the hole, and the expander rod is introduced into the expansible fixing plug through the rear end.

The problem of the invention is to improve an expansible fixing plug of the kind described hereinbefore so that the risk is reduced that an expander rod will exit laterally on being introduced into the expansible fixing rod.

### SUMMARY OF THE INVENTION

The expansible fixing plug according to the invention has at least two limbs extending in a longitudinal direction of the fixing plug, it being understood that “in a longitudinal direction of the fixing plug” does not only mean a straight, axially parallel course but also, for example, helical or wavy limbs.

Expansion elements project from the limbs in opposite circumferential directions of the expansible fixing plug, the expansion elements that project from the different limbs extending between one another and alternating with one another in the longitudinal direction of the fixing plug. The limbs and the expansion elements surround a hollow space extending in the longitudinal direction of the fixing plug and forming an expansion channel into which an expander rod can be introduced for expansion of the expansible fixing plug. The expander rod is, for example, a nail, a screw-nail or a screw. It can also be referred to as a fastening means because an article to be fastened is fastened to it and/or by it.

The expander rod pushes the limbs and the expansion elements of the expansible fixing plug outwards, which is to say that it expands the expansible fixing plug. On expansion, the expansion elements pivot outwards about axes which extend at least substantially in the longitudinal direction of the fixing plug or on a slant at an angle to the longitudinal direction of the fixing plug. Pivoting is possible as a result of elastic and/or plastic deformability of the material from which the expansible fixing plug is made. In addition, the expansion elements are connected by extensible and tearable connectors, which extend on a slant relative to the longitudinal direction of the fixing plug. The connectors counteract the expander rod exiting the expansible fixing plug laterally between two expansion elements. Especially when the expansion elements have a spacing from one another, the connectors improve guidance of the expander rod in the expansible fixing plug on being introduced into the expansible fixing plug, as a result of which the risk of the expander rod exiting laterally is reduced. As a result, the expansible fixing plug expands over the entire length of its expansion region in the intended manner, which improves its anchoring in a hole in an anchoring substrate. The connectors do not counteract, or only slightly counteract, expansion, so that the expansion force is not, or only slightly, increased. The connectors especially have a strap-like cross-section, which is to say that they extend further in the circumferential and/or longitudinal direction than in the radial direction, the connectors having, compared to the expansion elements, a reduced cross-section, especially in the radial direction. At the same time, the connectors increase the strength of the expansible fixing plug against flexion, buckling and torsion. The slanting orientation of the connectors serves especially to increase the torsional strength, because the connectors, when the expansible fixing plug is twisted, are subjected to tension or compression, depending on their orientation, and are not—or only to a lesser extent—subjected to flexion as they would be in the case of a connector extending in the longitudinal direction of the fixing plug.

In an embodiment of the invention, extensible and tearable connectors are provided which connect expansion elements in pairs. This means that, in the case of the expansion elements arranged one after another in the longitudinal direction, there is no connection after every second expansion element. This embodiment of the invention facilitates expansion, with axial guidance of the expander rod in the expansible fixing plug deteriorating only slightly; as a result, the risk of the expander rod exiting laterally on being introduced into the expansible fixing plug is only slightly increased and, compared to an expansible fixing plug without connectors between the expansion elements, is still reduced.

In an embodiment of the invention, the connectors are provided only in a front region of the expansible fixing plug. In a rear portion of the expansion region of the expansible fixing plug there are no connectors provided between the expansion elements. The front portion is, for example, a front half of the expansion region of the expansible fixing plug or, for example, the first two to four or five expansion elements and/or the first one or two pairs of expansion elements. The risk that an expander rod will exit laterally on being introduced into the expansible fixing plug exists mainly in a front region of the expansible fixing plug because the expansible fixing plug has, in a rear portion of the expansion region, a customarily present cylindrical hollow shank which is closed in the circumferential direction and which guides the expander rod axially. Expansion elements in a rear portion of the expansion region of the expansible fixing plug which have no connectors but between which the expander rod first passes on being introduced into the expansible fixing plug can be expanded without the expansion force being increased as a result of the connectors. Once the expander rod reaches the front portion of the expansible fixing plug, it is guided by the connectors in the expansible fixing plug.

In an embodiment of the invention, two expansible and tearable connectors which extend on opposite slants relative to the longitudinal direction of the fixing plug are in each case provided between two expansion elements, it being possible for the angles at which the connectors extend on a slant relative to the longitudinal direction of the fixing plug to be the same or different. The connectors accordingly extend, for example, in a V-shape or X-shape between two expansion elements. This embodiment of the invention has the advantage of increased torsional strength and increases the reliability of the limbs of the expansible fixing plug not buckling out.

In an embodiment of the invention, hook-shaped expansion elements are provided which extend in between one another with a spacing. The hook shape can be so formed and arranged that the expansion elements extend behind one another and, on deformation of the expansible fixing plug, for example flexion or torsion, come into abutment against one another and increase the flexural, buckling and/or torsional strength of the expansible fixing plug.

The invention is explained hereinbelow in greater detail with reference to an exemplary embodiment shown in the drawings, in which:

### BRIEF DESCRIPTION OF THE DRAWINGS

FIG. 1 shows an expansible fixing plug according to the invention in a perspective view; and

FIG. 2 shows the expansible fixing plug of FIG. 1 in the expanded state.

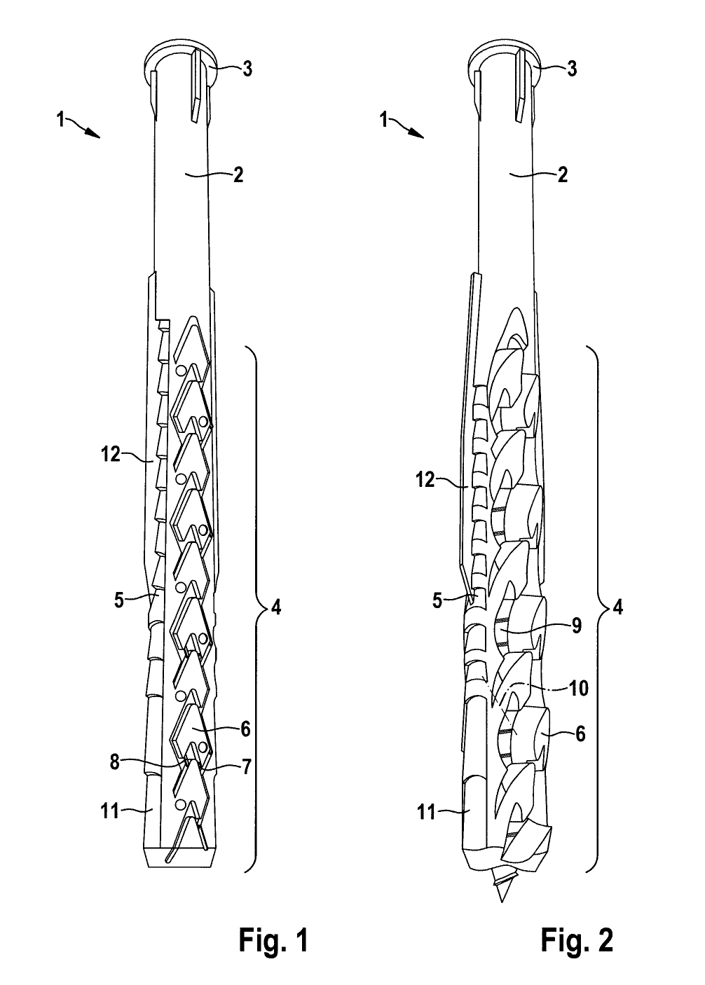

### DETAILED DESCRIPTION OF THE INVENTION

The expansible fixing plug 1 according to the invention shown in the drawings is, for example, made of plastic material by injection-moulding. It is sleeve-shaped and has, in a rear region, a tubular hollow shank 2 which is closed in the circumferential direction and which terminates in a hollow conical flange 3 at a rear end of the expansible fixing plug 1. To the front in the direction of introduction, adjacent to the hollow shank 2, is an expansion region 4, the “direction of introduction” being that direction in which the expansible fixing plug 1 is introduced into a drilled hole in the prescribed manner. Along the expansion region 4 there extend two limbs 5 in a longitudinal direction of the fixing plug up to a front end of the expansible fixing plug 1 where, just as at the rear of the expansion region 4 at the transition to the hollow shank 2, they are integrally connected to one another. The limbs 5 are arranged opposite one another on a circumference of the expansible fixing plug 1.

Expansion elements 6 project from longitudinal sides of the limbs 5 in opposite circumferential directions of the expansible fixing plug 1. The expansion elements 6 in each case project alternately from one, and then the other, limb 5, so that they extend in between one other in similar manner to a gear arrangement or the teeth of a zip fastener, albeit with a spacing from one another. The expansion elements 6 are hook-shaped; they project at an angle towards the rear from the limbs 5 and, after a bend in a mid-plane of the expansible fixing plug 1 between the limbs 5, they point at an angle towards the front. Alternatively, the expansion elements 6 can also, vice-versa, project from the limbs 5 at an angle towards the front and, after the bend, point at an angle towards the rear (not shown). The expansion elements 6 are not in contact with one another but rather, as said, there are spaces between them when the expansible fixing plug 1 is in the non-deformed state. As a result of their hooked shape, the expansion elements 6 which extend in between one other extend behind one another and connect the limbs 5 to one another by means of an interlocking connection with play which results from the spaces between the expansion elements 6.

The hook-shaped expansion elements 6 come up against one another—that is to say the interlocking connection between the expansion elements 6 comes into effect—when the expansible fixing plug 5 is bent or the limbs 5 move apart from one another. By this means, the expansion elements 6 increase the flexural and buckling strength of the expansible fixing plug 1 and prevent the limbs 5 from buckling out when the expansible fixing plug 5 is introduced into a hole (not shown) in an anchoring substrate. In addition, the expansion elements 6 increase the torsional strength of the expansible fixing plug 1 in the expansion region 4 when the expansion elements 6 come into abutment against one another on twisting of the expansible fixing plug 1—that is to say when the limbs 5 are subjected to helical deformation.

The front two pairs of expansion elements 6, that is to say the first and second expansion elements 6 and also the third and fourth expansion elements 6 are connected to one another by connectors 7, 8. The strap-like connectors 7, 8 are bridging elements of reduced diameter compared to the expansion elements 6; they are deformable and tearable. They extend on a slant relative to the longitudinal direction of the fixing plug from one expansion element 6 to corners of another of the hook-shaped expansion elements 6. Between the two pairs of expansion elements 6, and between the expansion elements 6 further to the rear in the expansion region 4 of the expansible fixing plug 1, the expansion elements 6 are not connected to one another but rather have the mentioned spacings from one another.

The limbs 5 and the expansion elements 6 surround, in the form of a sleeve, an expansion channel in coaxial extension of the hollow shank 2, into which an expander rod in the form of an expander screw 9 can be introduced, that is to say screwed. The clear width between the limbs 5 and expansion elements 6 in the expansion region 4 of the expansible fixing plug 1 is smaller than the internal diameter of the hollow shank 2 so that the expander screw 9 pushes the limbs 5 and the expansion elements 6 apart from one another and outwards, that is to say it expands the expansible fixing plug 1 in the expansion region 4, as can be seen in FIG. 2. On expansion, provided that the wall of the hole surrounding the expansible fixing plug 1 yields, the expansion elements 6 pivot outwards about pivot axes 10, one of which is shown by way of example in FIG. 2. The pivot axes 10 extend on a slant relative to the longitudinal direction of the fixing plug. The pivotability of the expansion elements 6 results from their deformability. In a soft building material such as, for example, aerated concrete, the expansion elements 6 mould themselves into the wall of the hole and cause the expansible fixing plug to dig in in a hole in an anchoring substrate.

The connectors 7, 8 between the expansion elements 6 in the front portion of the expansion region 4 guide the expander screw 9 forming the expander rod in the expansion channel between the expansion elements 6 and the limbs 5. The connectors 7, 8 prevent the expander screw 9 from laterally exiting the expansible fixing plug 1 between the expansion elements 6. Because the expander screw 9 is axially guided at the rear in the hollow shank 2 of the expansible fixing plug 1, the risk of its already laterally exiting in the rear portion of the expansion region 4 is low, for which reason it is possible to dispense with connectors 7, 8 there. However, the invention in no way excludes connectors 7, 8 in the rear portion of the expansion region 4. Because the expansion elements 6 in the rear portion of the expansion region 4 are not connected to one another, they can be expanded more readily, that is to say the screwing-in torque of the expander screw 9 is less. Once the expander screw 9 reaches the front portion of the expansion region 4, the expansible fixing plug 1 is held in the hole by the expansion elements 6 to the rear, which have already been expanded, so that it does not rotate together with the expander screw 9.

As a result of their orientation on a slant, the connectors 7, 8 between the two front pairs of expansion elements 6, when compared to connectors oriented in the longitudinal direction, not only improve guidance of the expander screw 9 in the expansible fixing plug 1 but also increase the torsional strength.

On their outsides, the limbs 5 have a Christmas-tree profile 11 in order to improve the anchoring of the expansible fixing plug 1 in a hole in an anchoring substrate. In the rear portion of the expansion region 4, two longitudinal ribs 12 arranged in an axial plane of the expansible fixing plug 1 project outwards from the limbs 5.

### LIST OF REFERENCE NUMERALS

### Expansible Fixing Plug

1 expansible fixing plug
2 hollow shank
3 flange
4 expansion region
5 limb
6 expansion element
7 connector
8 connector
9 expander screw
10 axis
11 Christmas-tree profile
12 longitudinal rib

1. An expansible fixing plug having at least two limbs extending in a longitudinal direction of the fixing plug and having expansion elements which project from the limbs in opposite circumferential directions, the limbs and the expansion elements surrounding a hollow space which extends in the longitudinal direction of the fixing plug and which forms an expansion channel into which an expander rod can be introduced for expansion of the expansible fixing plug, wherein the expansion elements, on expansion, pivot outwards around axes extending in the longitudinal direction of the fixing plug or on a slant; and in that expansion elements are connected by extensible and tearable connectors which extend on a slant to the longitudinal direction of the fixing plug.

2. The expansible fixing plug according to claim 1, wherein the expansion elements are connected in pairs by extensible and tearable connectors.

3. The expansible fixing plug according to claim 1, wherein only expansion elements in a front portion of the expansible fixing plug are connected by the connectors.

4. The expansible fixing plug according to claim 1, wherein the expansion elements are connected in pairs by, in each case, two extensible and tearable connectors, which extend on opposite slants to the longitudinal direction of the fixing plug.

5. The expansible fixing plug according to claim 1, wherein the expansion elements are hook-shaped and extend between one another with a spacing.

6. The expansible fixing plug according to claim 2 wherein only expansion elements in a front portion of the expansible fixing plug are connected by the connectors.

7. The expansible fixing plug according to claim 2, wherein the expansion elements are connected in pairs by, in each case, two extensible and tearable connectors, which extend on opposite slants to the longitudinal direction of the fixing plug.

8. The expansible fixing plug according to claim 3, wherein the expansion elements are connected in pairs by, in each case, two extensible and tearable connectors, which extend on opposite slants to the longitudinal direction of the fixing plug.
